(19) United States
(12) Patent Application Publication
(10) Pub. No.: US 2012/0185839 A1
(43) Pub. Date: Jul. 19, 2012

(54) PROGRAM EXECUTION METHOD, COMPUTER SYSTEM, AND PROGRAM EXECUTION CONTROL PROGRAM

(75) Inventors: Akira Nikaido, Yokohama (JP); Koichi Shimazaki, Yokohama (JP); Naotsugu Toume, Yokohama (JP)

(73) Assignee: Hitachi, Ltd.

(21) Appl. No.: 13/390,070

(22) PCT Filed: Mar. 25, 2010
(86) PCT No.: PCT/JP2010/055985

§ 371 Date: Mar. 21, 2012

(51) Int. Cl. G06F 9/44

(52) U.S. Cl. 717/168

(57) ABSTRACT

It is provided a program execution method, for executing an application program including at least one processing module. The at least one processing module includes at least one process, and being managed with an identification. The method includes the steps of: determining whether the processing module to be executed needs modification by comparing the identification of a running processing module and the identification of a deployed processing module; determining the identification of the processing module to be executed based on history information, which indicates whether the each process included in the at least one processing module has been executed, and on information indicating a different process between the at least one process included in the running processing module and the at least one process included in the deployed processing module; and calling up the processing module by specifying the identification of the determined processing module.

### BACKGROUND OF THE INVENTION

This invention relates to a computer system which executes an application program, and to a technology for modifying an application program even while the application program is running.

In recent years, users are provided, over a network, with various services such as online banking services, online shopping sites, and bullet train and airline reservation services. Most of those services are built with the use of a Web application server, and providers of the services frequently modify their systems through function expansion, security improvement, bug correction, and the like in order to deal with users' diverse needs. Those modifications include a modification of software such as an application.

To modify a system, system reboot is generally necessary after the whole application is replaced. If the application to be modified is running at the time, the modification needs to wait until the execution of the application is finished, or forcibly terminating the running application is required. Consequently, there are chances that the application cannot be modified immediately or that the forced termination of processing causes processing inconsistency even when it is only a part of the application (such as a modification of input confirmation processing that accompanies the addition of a checkbox to a screen) that needs to be corrected or when a defect in an existing function is to be corrected soon.

The resultant problem is that the application cannot be modified until the next scheduled maintenance even when it looks to users that the correction would take no time, when correcting the defect immediately is imperative, or when the extent of modification is small, thereby lowering the quality of service. Quick application modification is thus demanded.

To satisfy the demand, the following technologies for modifying an application have been proposed.

JP 2008-250427 A, for example, describes a technology with which, when an instruction to update an application is issued in a computer system that has a load balancing function for balancing, among servers in operation, load created due to processing requests from a plurality of servers and clients, the application is modified without suspending the system by shutting down servers that are low in operating rate first to upgrade the application.

JP 2006-235838 A, for example, describes a technology with which new software is distributed on a preset schedule and, when there is an older version of the new software distributed, a switch to the new software is made.

### SUMMARY OF THE INVENTION

With the technologies of JP 2008-250427 A and JP 2006-235838 A described above, an application cannot be modified until predetermined modification timing (user log-out, the time when the application finishes booting up, the time of reboot, or the like). The problem with this is that application modification cannot take place even if there is a time during the execution of application processing when the application can be modified without causing processing inconsistency.

It is an object of this invention to quickly modifying an application by loosening limitations on application modification timing.

The representative one of inventions disclosed in this application is outlined as follows. There is provided a program execution method, which is to be performed in a computer for executing an application program including at least one processing module. The at least one processing module includes at least one process, and being managed with an identification. The computer includes an AP update determining unit for determining modification timing of a processing module to be executed, and a processing module calling unit for calling up a processing module. The program execution method includes the steps of: determining, by the AP update determining unit, whether the processing module to be executed needs modification by comparing the identification of a running processing module and the identification of a deployed processing module; determining, by the AP update determining unit, the identification of the processing module to be executed based on history information, which indicates whether the each process included in the at least one processing module has been executed, and on information indicating a different process between the at least one process included in the running processing module and the at least one process included in the deployed processing module; and calling up, by the processing module calling unit, the processing module by specifying the identification of the processing module determined by the AP update determining unit.

According to an embodiment of this invention, an application can be modified at a time during the execution of application processing when processing inconsistency is not caused, instead of predetermined timing.

### BRIEF DESCRIPTION OF THE DRAWINGS

FIG. 1 is an overall configuration diagram of a computer system according to a first embodiment of this invention.

FIG. 2 is a diagram illustrating a functional configuration example of the application according to the first embodiment of this invention.

FIG. 3 is a configuration diagram of processing modules stored in the processing module storing unit according to the first embodiment of this invention.

FIG. 4A is a hardware configuration diagram of the computer system according to the first embodiment of this invention.

FIG. 4B is a hardware configuration diagram of the client terminal according to the first embodiment of this invention.

FIG. 5A is a diagram illustrating an example of the configuration of latest version information according to the first embodiment of this invention.

FIG. 5B is a diagram illustrating an example of the configuration of processing module information according to the first embodiment of this invention.

FIG. 5C is a diagram illustrating an example of the configuration of the work group definition according to the first embodiment of this invention.

FIG. 6A is a diagram illustrating an example of the configuration of executed version information according to the first embodiment of this invention.

FIG. 6B is a diagram illustrating an example of the configuration of the execution history according to the first embodiment of this invention.

FIG. 7 is a flow chart illustrating a processing module information updating processing according to the first embodiment of this invention.

FIG. 8 is a flow chart illustrating a procedure of a running processing interrupting processing according to the first embodiment of this invention.

FIG. 9 is a flow chart illustrating a procedure of an AP update determining processing according to the first embodiment of this invention.

FIG. 10 is a flow chart illustrating a procedure of a processing module calling processing according to the first embodiment of this invention.

FIG. 11A is a diagram illustrating an example of application modification timing according to the first embodiment of this invention.

FIG. 11B is a diagram illustrating an execution history in the case of FIG. 11A.

FIG. 11C is a diagram illustrating an example of application modification timing according to the first embodiment of this invention.

FIG. 12 is an overall configuration diagram of a computer system according to a second embodiment of this invention.

FIG. 13 is a diagram illustrating an example of the configuration of the work group definition according to the second embodiment of this invention.

FIG. 14 is a flow chart illustrating a procedure of a AP update determining processing according to the second embodiment of this invention.

FIG. 15 is a flow chart illustrating a procedure of a execution history initializing processing according to the second embodiment of this invention.

FIG. 16 is an overall configuration diagram of a computer system according to a third embodiment of this invention.

FIG. 17 is a configuration diagram of processing modules stored in the processing module storing unit according to the third embodiment of this invention.

FIG. 18A is a diagram illustrating an example of the configuration of the latest version information according to the third embodiment of this invention.

FIG. 18B is a diagram illustrating an example of a configuration of processing module information according to the third embodiment of this invention.

FIG. 19 is a diagram illustrating an example of executed version information according to the third embodiment of this invention.

FIG. 20 is a flow chart illustrating a procedure of a processing module information updating processing according to the third embodiment of this invention.

FIG. 21 is a flow chart illustrating a procedure of an AP update determining processing according to the third embodiment of this invention.

FIG. 22 is a flow chart illustrating a procedure of a processing module calling processing according to the third embodiment of this invention.

### DETAILED DESCRIPTION OF THE PREFERRED EMBODIMENTS

An overview of the invention disclosed herein is described first. In this invention, it is determined whether or not executed processing and processing to be modified include the same processing is determined according to the time an instruction to modify an application is given and, application modification timing (in other words, identification information of a processing module to be called up) is determined based on the result of this determination. The result of this determination is then used to specify and call up a processing module.

Whether or not the same processing is included is determined for each cluster of processing processes included in a processing module (work group).

Identification information used in this invention is information for identifying a processing module to be called up, and is a number for discriminating a pre-modification processing module and a post-modification processing module from each other when a processing module included in an application is modified. For instance, version number (version) whose value increases by 1 each time the processing module is modified can be used. Any other information than version can be used as long as which processing module is to be called up is identified from the information.

In embodiments of this invention, the following processing units are included in order to implement the above-mentioned method:

(1) Processing module information updating unit which modifies processing module information and post-modification identification information based on a deployed module;

(2) Running processing interrupting unit which obtains the name of processing currently executed by an application to interrupt the execution of the processing;

(3) AP update determining unit which determines when to modify a processing module with the use of processing module information, which indicates modified processing for each piece of processing module identification information, and an execution history of each processing process; and

(4) Processing module calling unit which uses processing module information and the result of determination by the AP update determining unit to identify and call up a processing module from identification information of an processing module currently executed.

The embodiments of this invention are described below in detail with reference to the drawings. A first embodiment is described first. The following description of the embodiments takes application update (upgrade) as an example of application modification, but application modification in this invention is not limited to upgrade. Rollback and a temporary modification of a function can be given as other examples.

### First Embodiment

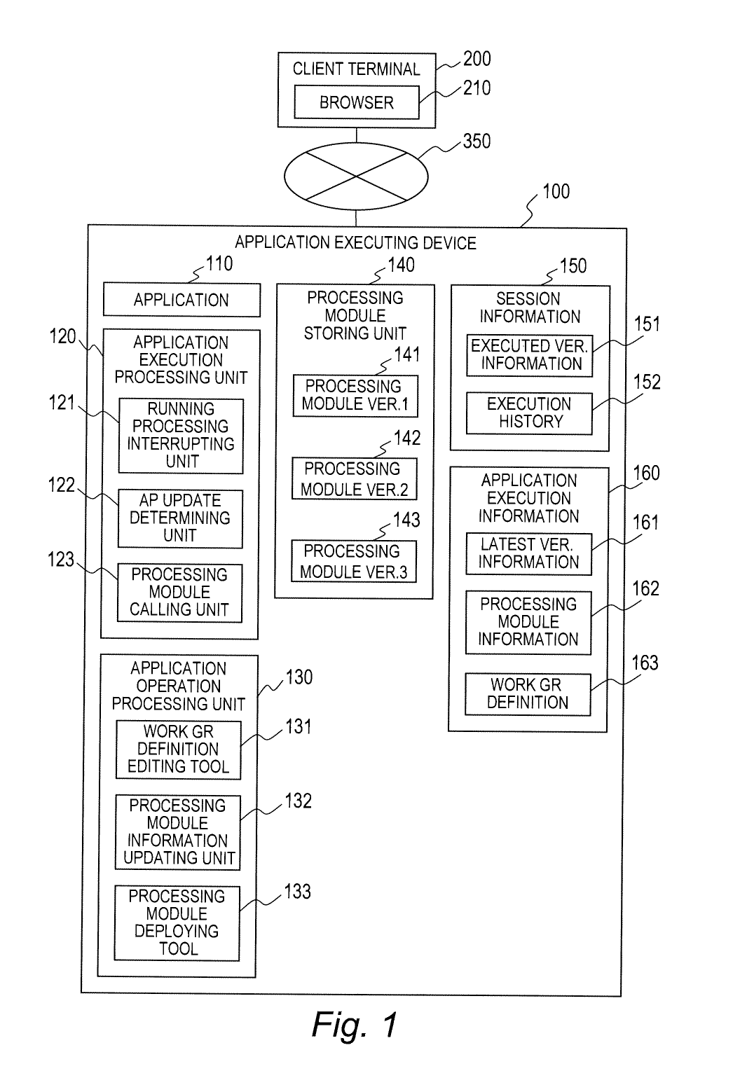

FIG. 1 is an overall configuration diagram of a computer system according to the first embodiment of this invention.

The computer system of the first embodiment includes an application executing device 100 and a client terminal 200, which are coupled to each other by a network 350.

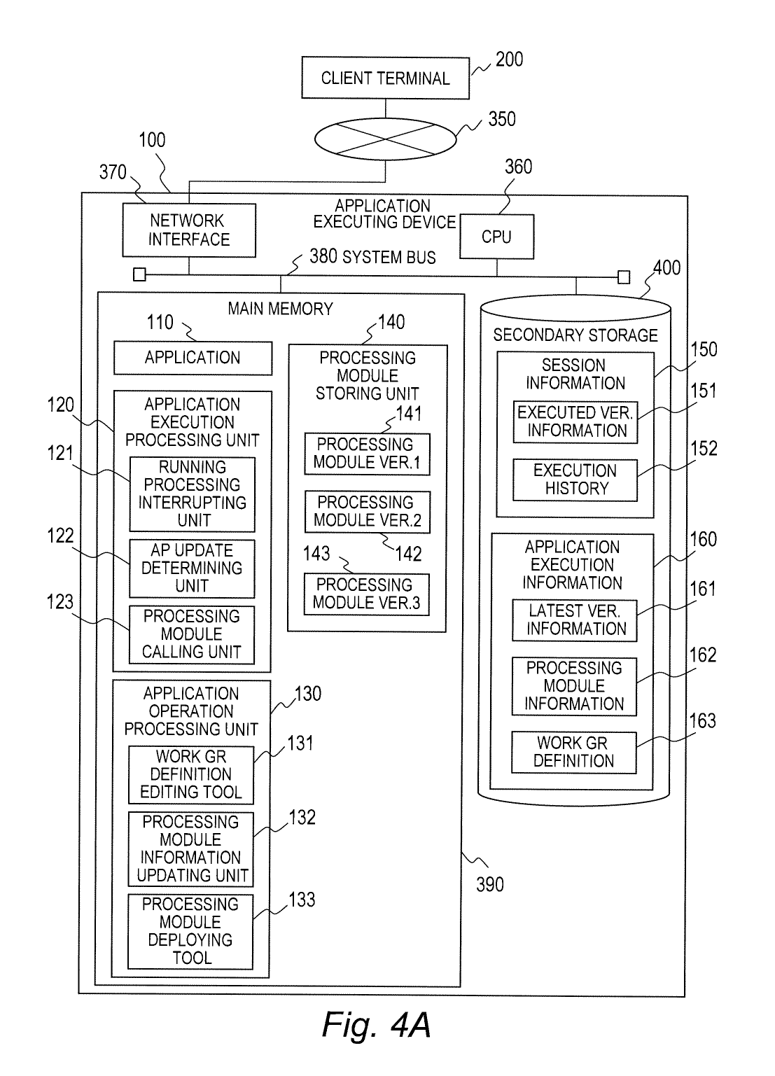

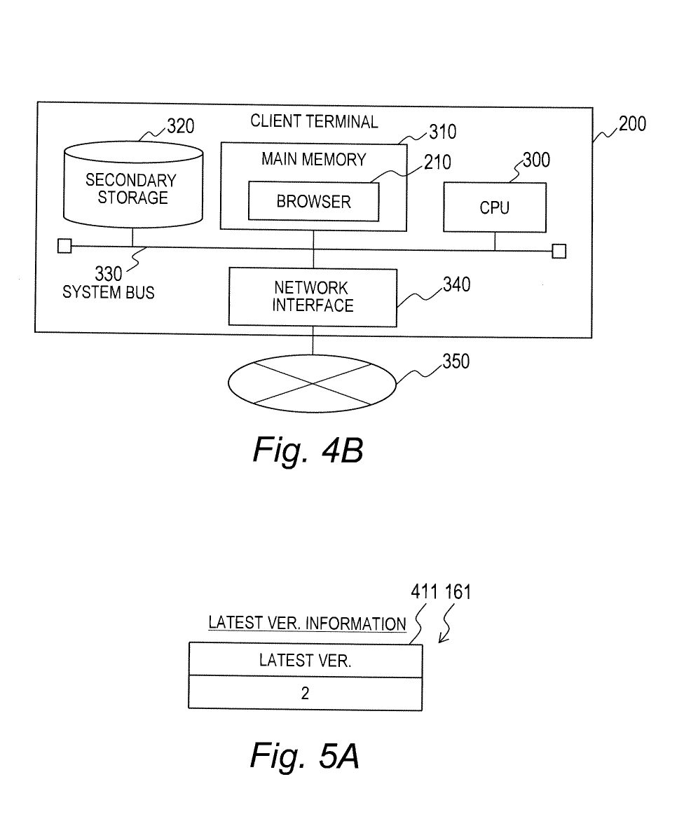

The application executing device 100 is a computer which includes a processor, a memory, and an interface, and details of the hardware configuration thereof are described with reference to FIG. 4A.

The application executing device 100 includes an application 110, an application execution processing unit 120, an application operation processing unit 130, a processing module storing unit 140, session information 150, and application execution information 160. The application execution processing unit 120 and the application operation processing unit 130 function by executing an installed program with the processor.

The application 110 is a program that processes a processing request from the client terminal 200 on the application executing device 100, and is executed by the processor.

The application execution processing unit 120 includes a running processing interrupting unit 121, an AP update determining unit 122, and a processing module calling unit 123.

The running processing interrupting unit 121 obtains the name of processing that is being executed. The AP update determining unit 122 determines the version of a processing module that can be modified. The processing module calling unit 123 calls up a processing module of a post-modification version. The operations of the running processing interrupting unit 121, the AP update determining unit 122, and the processing module calling unit 123 are described later with reference to FIGS. 8, 9, and 10, respectively.

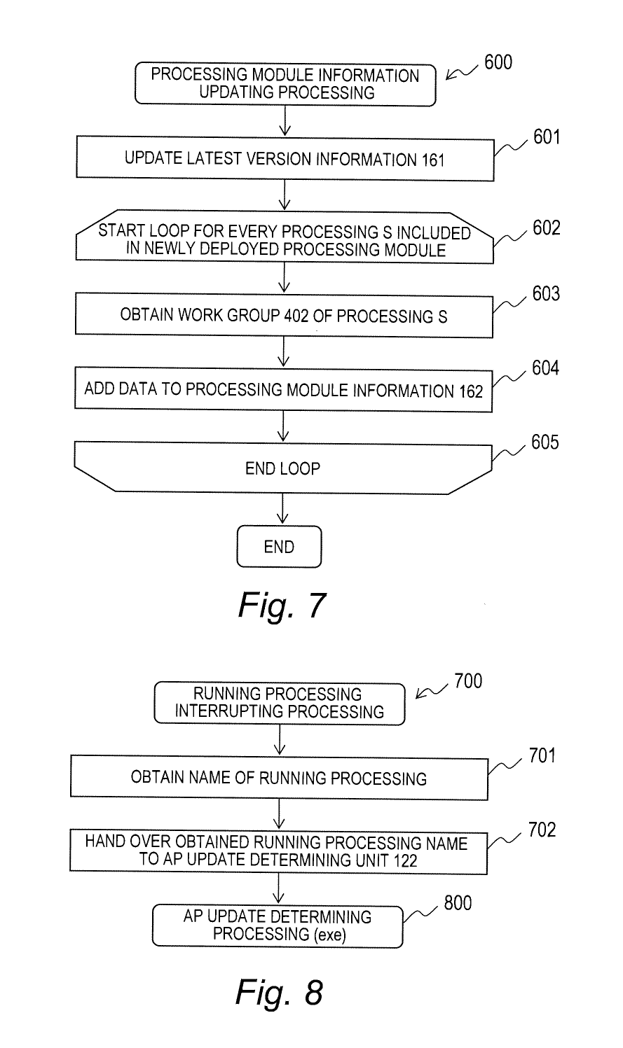

The application operation processing unit 130 includes a work group definition editing tool 131, a processing module information updating unit 132, and a processing module deploying tool 133. The work group definition editing tool 131 is used by a user to edit work group definition 163, which is included in the application execution information 160. The processing module deploying tool 133 stores a new processing module in the processing module storing unit 140 and calls up the processing module information updating unit 132 in order to update processing module information 162. The processing module information updating unit 132 updates the processing information module 162 about an added processing module. The operation of the processing module information updating unit 132 is described later with reference to FIG. 7.

The processing module storing unit 140 stores processing modules 141, 142, and 143 of different versions. Processing modules exist on a work group basis. A single processing module may include a plurality of work groups.

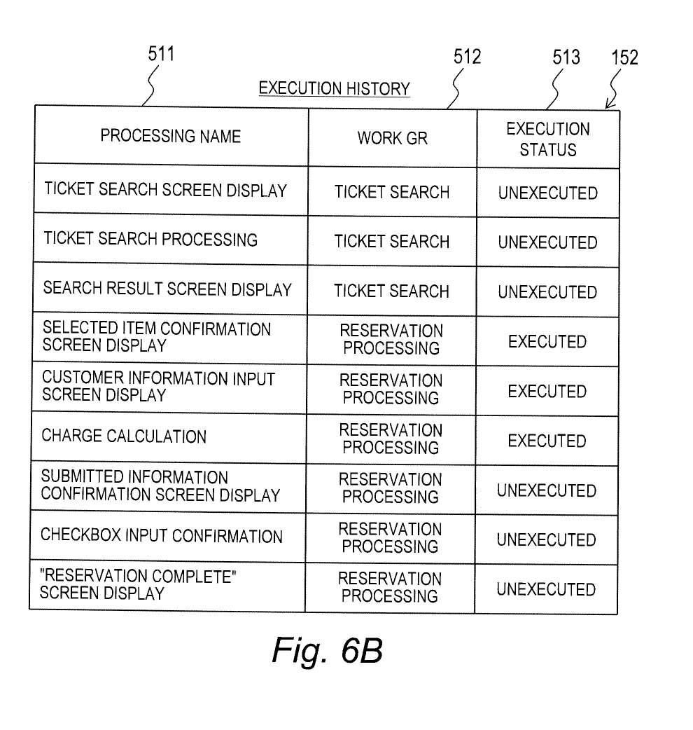

The session information 150 is information generated for each session of a user who uses an application, and includes executed version information 151 and an execution history 152. The executed version information 151 is information indicating the version of a processing module that is being executed at present (see FIG. 6A). The execution history 152 is information indicating for each processing process whether or not the processing process has been executed (FIG. 6B).

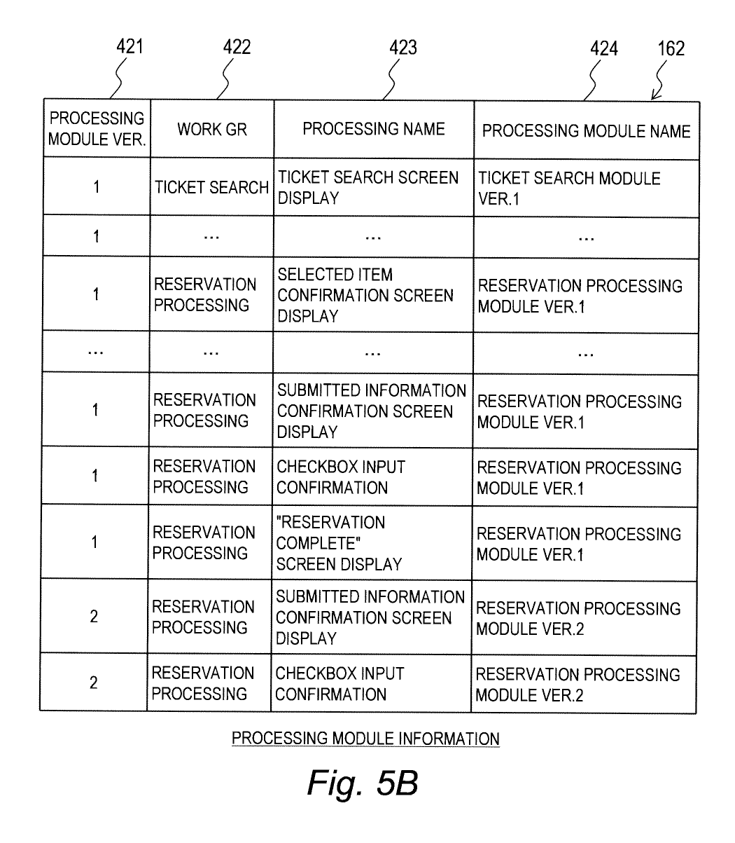

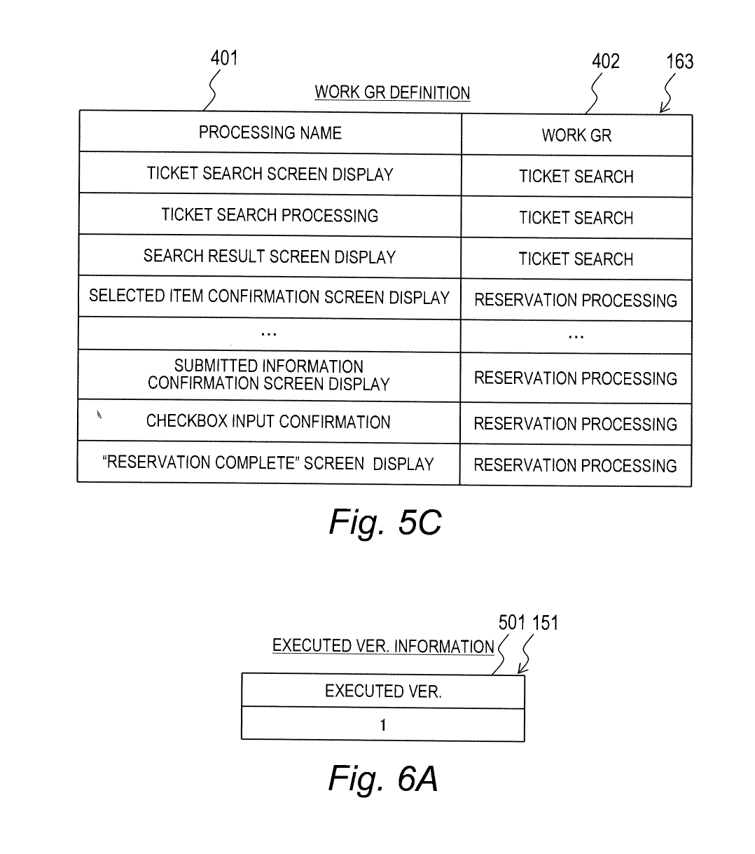

The application execution information 160 includes latest version information 161, the processing module information 162, and the work group definition 163. The latest version information 161 is information indicating the latest version of a processing module (see FIG. 5A). The processing module information 162 is information defining which processing module is to be called up for each processing module version (see FIG. 5B). The work group definition 163 is information indicating for each processing process a work group that includes the processing process (see FIG. 5C). A work group is a processing group which is set for each cluster of processing processes separated from another cluster of processing processes.

The client terminal 200 is a computer which includes a processor, a memory, and an interface, and executes a browser 210. The browser 210 is a program that has a function of transmitting an HTTP request to the application executing device 100 in response to the user's processing request. Although only one client terminal 200 is illustrated in the drawings, a plurality of client terminals 200 may be included.

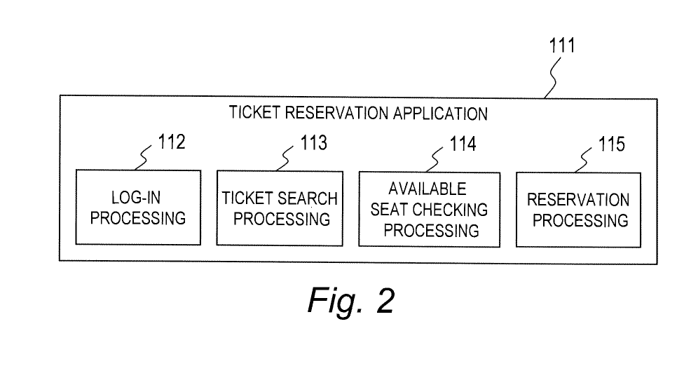

FIG. 2 is a diagram illustrating a functional configuration example of the application 111 in the first embodiment.

The application 111 includes a plurality of processing processes executed in response to a request from the client terminal 200, and the processing processes are executed sequentially by the processor of the application executing device 100.

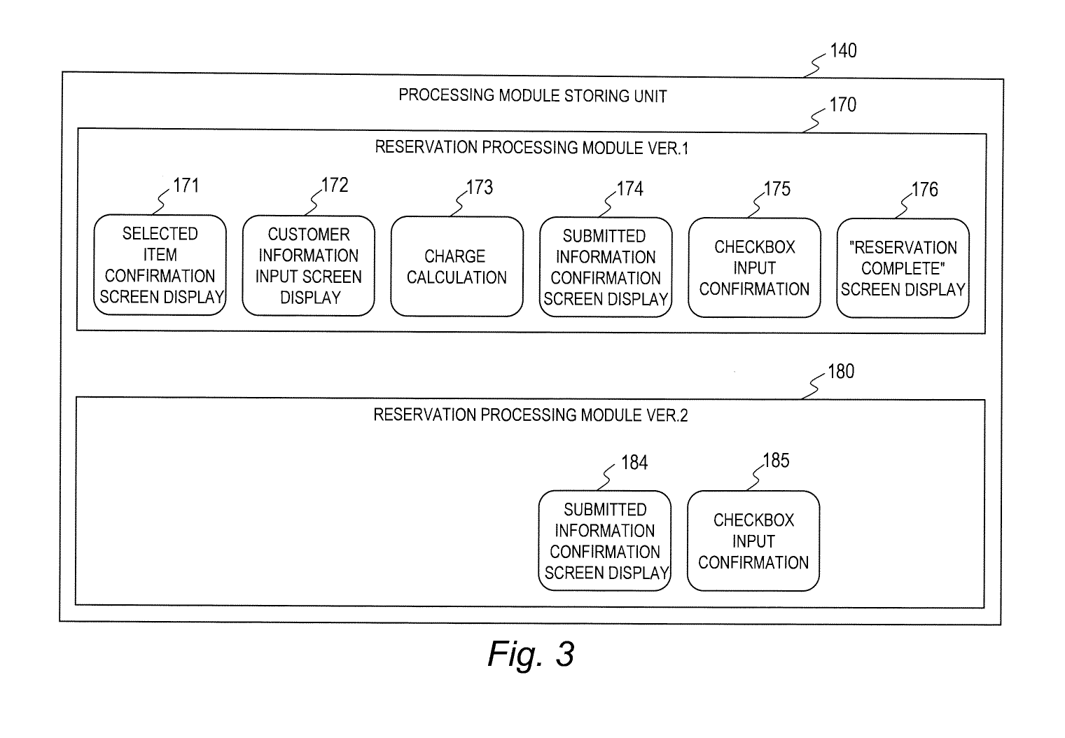

For example, the ticket reservation application 111 of FIG. 2 includes a log-in processing module 112, a ticket search processing module 113, an available seat checking processing module 114, and a reservation processing module 115. Those modules each include at least one processing processes (see FIG. 3) and are each associated with a work group 402 (or work groups 402) in the work group definition 163.

FIG. 3 is a configuration diagram of processing modules stored in the processing module storing unit 140 in the first embodiment.

The processing modules are provided on a work group basis and also on a processing module version basis. In the case where the version of a processing module associated with one work group is upgraded, only modified (upgraded) processing in this work group is included in a processing module of the next version. Some work groups therefore may not include a processing module of a specific version. An application may contain only one work group (one processing module).

For example, a reservation processing module version 1 (170) of FIG. 3 includes selected item confirmation screen display processing 171, customer information input screen display processing 172, charge calculation processing 173, submitted information confirmation screen display processing 174, checkbox input confirmation processing 175, and “reservation complete” screen display processing 176, which correspond to processing processes included in a work group. A reservation processing module version 2 (180) which is an upgraded version includes submitted information confirmation screen display processing 181 and checkbox input confirmation processing 182 in which processing specifics have been modified. The reservation processing module version 1 (170) is included in the processing module version 1 (141), and the reservation processing module version 2 (180) is included in the processing module version 2 (142).

FIG. 4A is a hardware configuration diagram of the computer system in the first embodiment and FIG. 4B is a hardware configuration diagram of the client terminal in the first embodiment.

The client terminal 200 is a computer that includes a processor 300, a main memory 310, secondary storage (for example, a hard disk drive) 320, and a network interface 340, and that connects those devices via a system bus 330.

The main memory 310 is, for example, a semiconductor memory and stores a program (e.g., a browser program 210) executed by the processor 300.

The network interface 340 is coupled to the network 350 and follows a given protocol in exchanging data with a device (the application executing device, for example) coupled to the network 350.

The application executing device 100 is a computer that includes a processor 360, a network interface 370, a main memory 390, and secondary storage (for example, a hard disk drive) 400, and that connects those devices via a system bus 380.

The network interface 370 is coupled to the network 350 and follows a given protocol in exchanging data with a device (the client terminal 200, for example) coupled to the network 350.

The main memory 390 is, for example, a semiconductor memory and stores various programs executed by the processor 360, specifically, programs for enabling the application 110, i.e., processing modules stored in the processing module storing unit 140, the application execution processing unit 120, and the application operation processing unit 130, to function.

The secondary storage 400 is large-capacity storage such as a hard disk drive, and stores the session information 150 and the application information 160.

FIGS. 5A to 5C are diagrams illustrating an example of the configuration of the application execution information 160 in the first embodiment. FIG. 5A illustrates the latest version information 161, FIG. 5B illustrates the processing module information 162, and FIG. 5C illustrates the work group definition 163.

As illustrated in FIG. 5A, the latest version information 161 includes a latest version 411 which indicates the latest version among processing modules stored in the processing module storing unit 140.

As illustrated in FIG. 5B, the processing module information 162 includes a processing module version 421, a work group 422, a processing name 423, and a processing module name 424. The processing module version 421 is the version of a processing module. The work group 422 is the name of a work group. The processing name 423 is the name of a processing process included in a work group. The processing module name 424 is the name of a processing module used by the processing module calling unit 123 to call up a module.

As illustrated in FIG. 5C, the work group definition 163 includes a processing name 401 and a work group 402. The processing name 401 is the name of a processing process included in a work group and uses a common name shared with the processing name 423 of the processing module information 162. The work group 402 is the name of a group which is a cluster of processing processes, and uses a common name shared with the work group 422 of the processing module information 162.

FIGS. 6A and 6B are diagrams illustrating an example of the configuration of the session information 150 in the first embodiment. FIG. 6A illustrates the executed version information 151 and FIG. 6B illustrates the execution history 152.

As illustrated in FIG. 6A, the executed version information 151 includes an executed version 501, which indicates for each processing process that is being run at present the processing module version of the processing process. A version value stored as the executed version 501 is the value of the latest version 411 that is obtained from the latest version information 161 at the start of a user session.

As illustrated in FIG. 6B, the execution history 152 includes a processing name 511, a work group 512, and an execution status 513. The processing name 511 is the name of a processing process included in a work group, and uses a common name shared with the processing name 423 of the processing module information 162. The work group 512 is the name of a group which is a cluster of processing processes, and uses a common name shared with the work group 422 of the processing module information 162. The execution status 513 indicates for each processing process whether or not the processing process has been executed, and one of “executed” and “unexecuted” is stored.

The execution history 152 in the first embodiment is initialized when a session with the client terminal 200 is established in the log-in processing 112. Alternatively, the execution history 152 may be initialized at the conclusion of the session.

Processing executed by the application executing device 100 is described next.

The running processing interrupting unit 121, the AP update determining unit 122, and the processing module calling unit 123 which constitute the application execution processing unit 120 are executed when the application 110 processes a request from the browser 210 of the client terminal 200. The processing units constituting the application execution processing unit 120 are executed for each processing process of the application in the following order: the running processing interrupting unit 121; the AP update determining unit 122; and the processing module calling unit 123.

The processing module information updating unit 132 of the application operation module 130 updates the processing module information 162 when a processing module is newly stored in the processing module storing unit 140.

FIG. 7 is a flow chart illustrating the processing that is executed by the processing module information updating unit 132 in the first embodiment.

First, an operator uses the processing module deploying tool 133 to store a new processing module in the processing module storing unit 140. Thereafter, the processing module deploying tool 133 calls up the processing module information updating module 132, which executes processing module information updating processing 600.

The processing module information updating unit 132 updates a value stored as the latest version 411 of the latest version information 161 with a value obtained by incrementing the stored value by 1, and sets the latest version 411 to a variable V (Step 601).

For every processing (S) included in the newly deployed processing module, a procedure from Step 603 to 604 is repeated (Step 602).

The work group definition 163 is searched for data in which the value of the processing name 410 equals the processing S, the work group 402 of the found data is obtained, and the obtained work group 402 is set to a variable G (Step 603).

Data containing the following items is then added to the processing module information 162 (Step 604).

Processing module version 421=V

Work group 422=G

Processing name 423=S

Processing module name 424=S+“module” +V

After the procedure from Step 603 to 604 is finished for every processing S, the loop is ended (Step 605).

FIG. 8 is a flow chart illustrating a processing procedure that is executed by the running processing interrupting unit 121 in the first embodiment.

The running processing interrupting unit 121 first interrupts processing of the application that is being executed at present, obtains the name of the running processing, and sets the running processing name to a variable exe (Step 701). For example, an interruption of running processing in Java (Java is a registered trademark, hereinafter “Java +”) is implemented by class file conversion (which involves operating bytecode), processing trap on a Java® virtual machine, or the like.

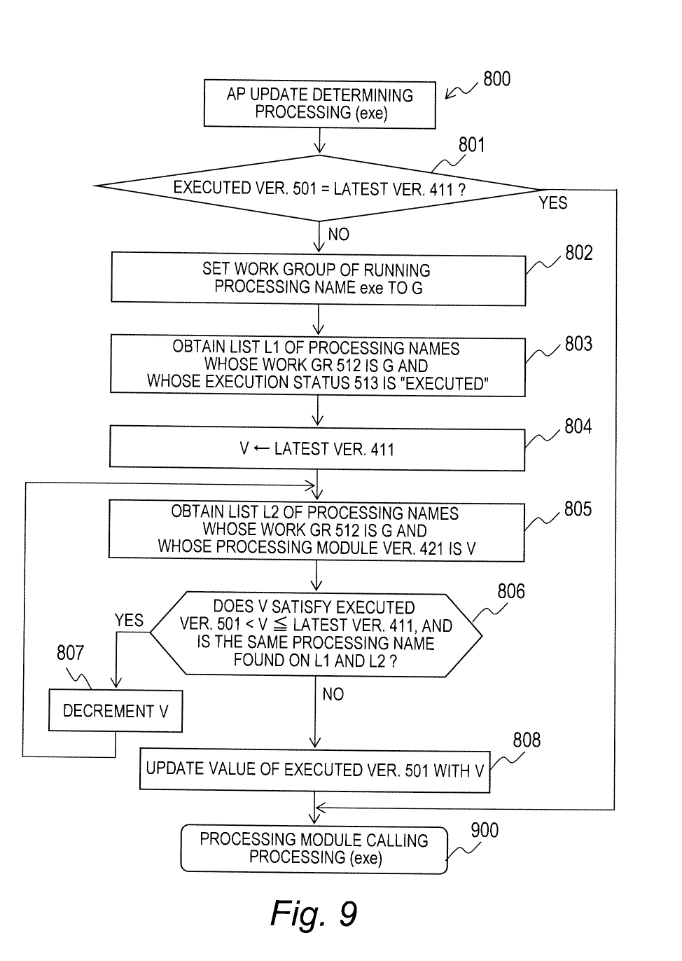

The running processing interrupting unit 121 then sets the obtained running processing name (exe) to a parameter of the AP update determining unit 122 (Step 702), and calls up the AP update determining unit 122, thereby starting AP update determining processing 800 (FIG. 9).

FIG. 9 is a flow chart illustrating a processing procedure that is executed by the AP update determining unit 122 in the first embodiment.

The running processing name exe is input as an argument in the AP update determining processing 800.

The AP update determining unit 122 first determines whether or not the latest version 411 of the latest version information 161 and the executed version 501 of the executed version information 151 match (Step 801). When it is found as a result that the two match, the AP update determining unit 122 calls up processing module calling processing 900 with the running processing name exe as an argument.

When the two do not match, on the other hand, the AP update determining unit 122 searches the work group definition 163 for data in which the value of the processing name 401 equals the running processing name exe, obtains the value of the work group 402 of the found data, and sets the obtained value of the work group 402 to G (Step 802).

Thereafter, the AP update determining unit 122 extracts from the execution history 152 the processing name 511 that has the work group G as the value of the work group 512 and “executed” as the execution status 513, to obtain a list L1 (Step 803).

The AP update determining unit 122 then sets the latest version 411 of the latest version information 161 as the initial value of the version V to be compared with the processing module version 421 of the processing module information 162 (Step 804).

The AP update determining unit 122 extracts from the processing module information 162 the processing name 423 that has the work group G as the value of the work group 422 and the version V as the value of the processing module version 421, to obtain a list L2 (Step 805).

The AP update determining unit 122 then determines whether or not the version V is higher than the executed version 501 of the executed version information 151 and is equal to or lower than the latest version 411 of the latest version information 161, and the same processing name is found on the list L1 and the list L2 (Step 806). The AP update determining unit 122 determines whether or not the same processing is found among executed processing on the list L1 and the version V processing on the list L2, in other words, whether or not processing to be modified has been executed.

When this condition is not satisfied, the AP update determining unit 122 decrements V by 1 (Step 807) and returns to Step 805.

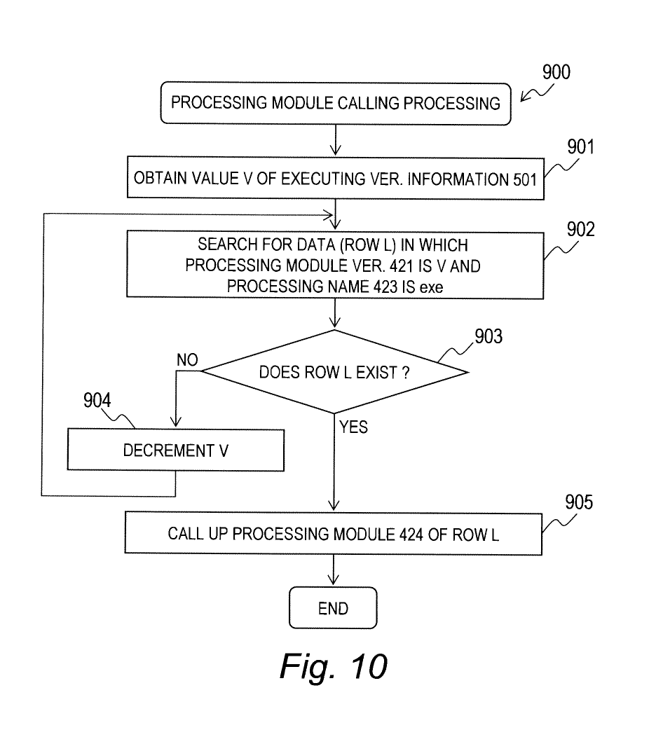

When the condition of Step 806 is satisfied, on the other hand, the AP update determining unit 122 updates the value of the executed version 501 of the executed version information 151 with V, and calls up the processing module calling unit 123, thereby starting processing module calling processing 900 (FIG. 10).

FIG. 10 is a flow chart illustrating a processing procedure that is executed by the processing module calling unit 123 in the first embodiment.

The running processing name exe is input as an argument in the processing module calling processing 900.

First, the value of the executed version 501 of the executed version information 151 is obtained and set to the variable V (Step 901).

The processing module calling unit 123 next searches the processing module information 162 for data (a row L) in which the value of the processing module version 421 equals the version V and the value of the processing name 423 equals the running processing name exe (Step 902), and determines whether or not the row L exists (Step 903).

When the row L is not found, the processing module calling unit 123 decrements the version V by 1 (Step 904) and returns to Step 902. When the row L is found, the processing module calling unit 123 calls up a module that has the processing module name 424 of the row L (Step 905).

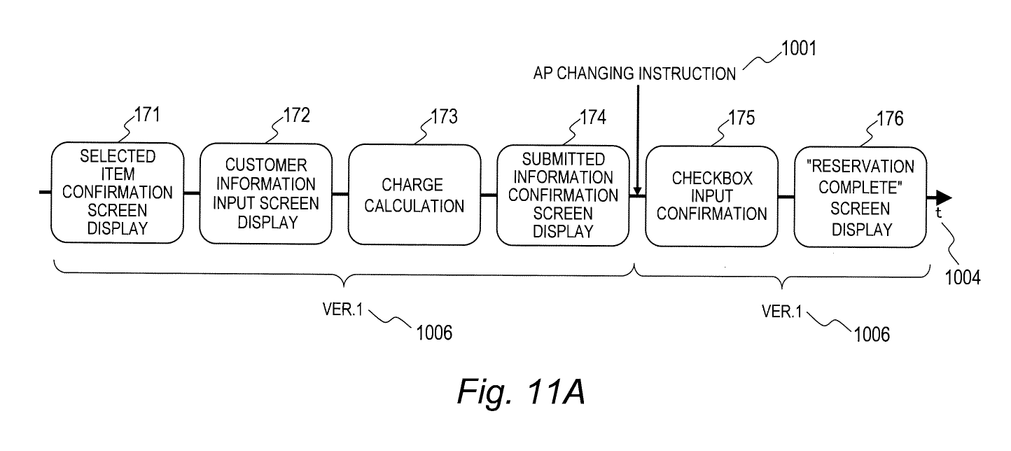

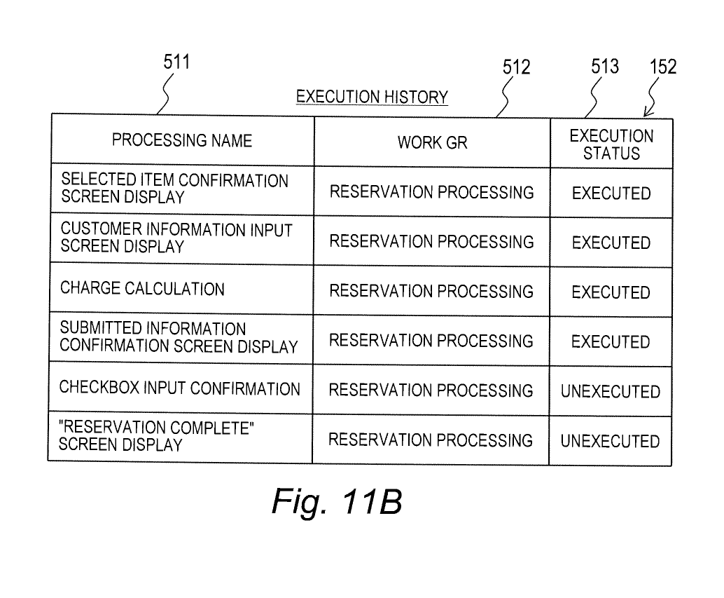

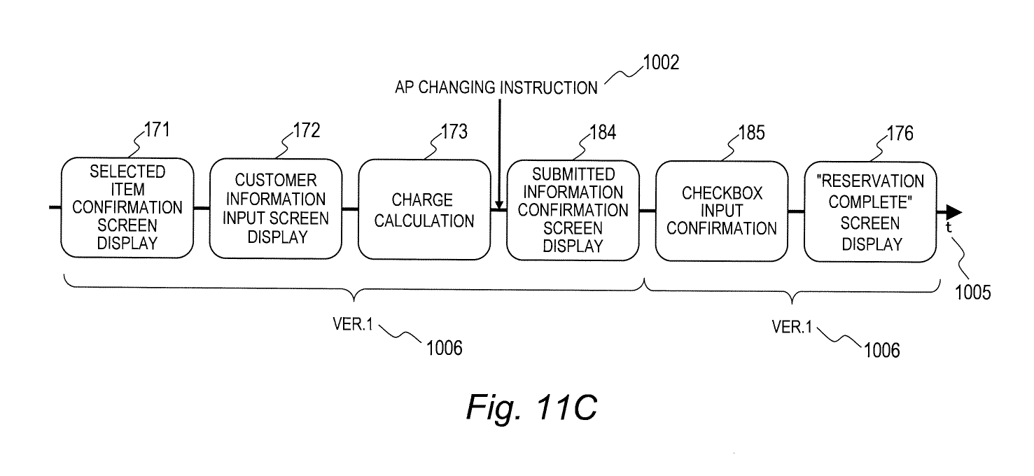

FIGS. 11A to 11C are diagrams illustrating an example of application modification timing in the first embodiment.

FIGS. 11A and 11C illustrate an example in which a difference in timing between AP modification instructions 1001 and 1002 varies application modification timing, and FIG. 11B illustrates the execution history 152 in the case of FIG. 11A.

The AP modification instructions 1001 and 1002 are issued at the time when a new module is deployed in the processing module storing unit 140 and the processing module updating unit 132 updates the latest version information 161 and the processing module information 162. In FIGS. 11A and 11C, processing processes of versions defined by the executed version 501 are executed along time axes 1004 and 1005.

As illustrated in FIG. 11A, in the case where the AP modification instruction 1001 is issued between the submitted information confirmation screen display processing 174 and the checkbox input confirmation processing 175, the execution history 152 is as illustrated in FIG. 11B, where the execution status 513 is “executed” for processing processes from the selected item confirmation screen display processing 171 to the submitted information confirmation screen display processing 174. The AP update determining unit 122 therefore compares the processing name 511 whose execution status is “executed” in the execution history 152 with the processing name 423 of the processing module information 162 (Steps 803 to 806 of FIG. 9), and finds out that “submitted information confirmation screen display” processing is on the list L1 and the list L2. An executed version 1006 of the checkbox input confirmation processing 175 and subsequent processing processes therefore does not change and remains 1.

In other words, in the case of FIG. 11A, submitted information confirmation screen display processing 184 has been executed which is a modified part of a reservation processing module version 2 (180) whose version is higher than the value of the executed version 501, and the modified processing module is therefore not executed in order to maintain processing consistency.

On the other hand, in the case where the AP modification instruction 1002 is issued between charge calculation processing 173 and the submitted information confirmation screen display processing 174 as illustrated in FIG. 11C, the execution history 152 is as illustrated in FIG. 6B, where the execution status 513 is “executed” for processing processes from the selected item confirmation screen display processing 171 to the charge calculation processing 173, and “unexecuted” for the submitted information confirmation screen display processing 174 and subsequent processing processes. The AP update determining unit 122 therefore compares the processing name 511 whose execution status 513 is “executed” in the execution history 153 with the processing name 423 of the processing module information 162 (Steps 803 to 806 of FIG. 9), and finds out that “submitted information confirmation screen display” processing exists on the list L2 but not on the list L1. The executed version 1006 of the submitted information confirmation screen display processing 174 and the subsequent processing processes is consequently changed to 2.

In other words, in the case of FIG. 11C, the submitted information confirmation screen display processing 184 has not been executed which is a modified part of the reservation processing module version 2 (180) whose version is higher than the value of the executed version 501, and processing consistency can be maintained even when the processing module version is upgraded at this timing. The modified processing module is therefore executed immediately.

As has been described, according to the first embodiment, when the application 100 processes a request from the browser 210 of the client terminal 200, the running processing interrupting unit 121, the AP update determining unit 122, and the processing module calling unit 123 can together call up a processing module for each user session while discriminating different versions of the processing module.

In addition, application modification can be timed with an update of the latest version information 161 and the processing module information 162. Specifically, whether or not an application is to be modified can be determined by determining whether to increase the value of the executed version 501 of currently running processing to the value of the latest version 411 from the result of comparing the execution history 152 and the processing module information 162.

An application can thus be modified quickly even while processing of the application is being executed, without causing processing inconsistency, instead of being modified at predetermined timing.

### Second Embodiment

A second embodiment is described next.

In the second embodiment of this invention, a source code of an application is analyzed to determine whether processing in a work group is start processing or end processing, and the execution history is initialized timed with one or both of the processing processes. This way, an application can be modified even while processing of the application is being executed without causing inconsistency between processing processes and, furthermore, even after the application executes processing of a modified part once.

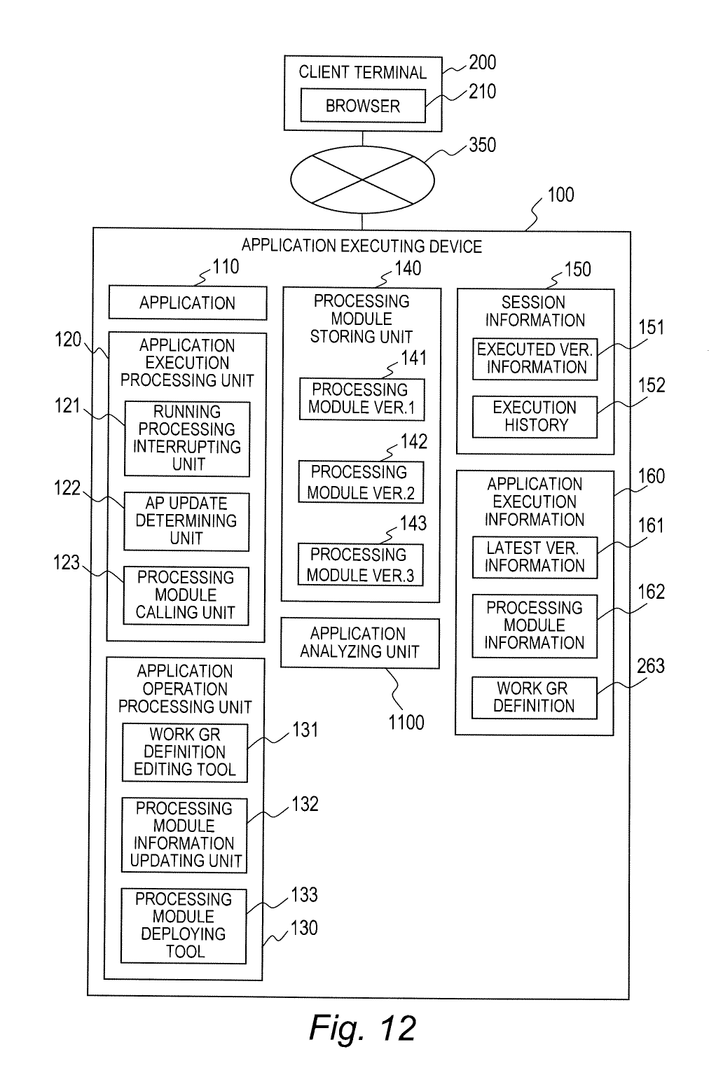

FIG. 12 is an overall configuration diagram of a computer system according to the second embodiment.

The computer system of the second embodiment includes the application executing device 100 and the client terminal 200, which are coupled to each other by the network 350. Components that are the same as in the first embodiment described above are denoted by the same symbols and descriptions thereof are omitted.

The application executing device 100 of the second embodiment includes an application analyzing unit 1100 in addition to the same components as those in the first embodiment described above. The application analyzing unit 1100 functions by executing an installed program with the processor.

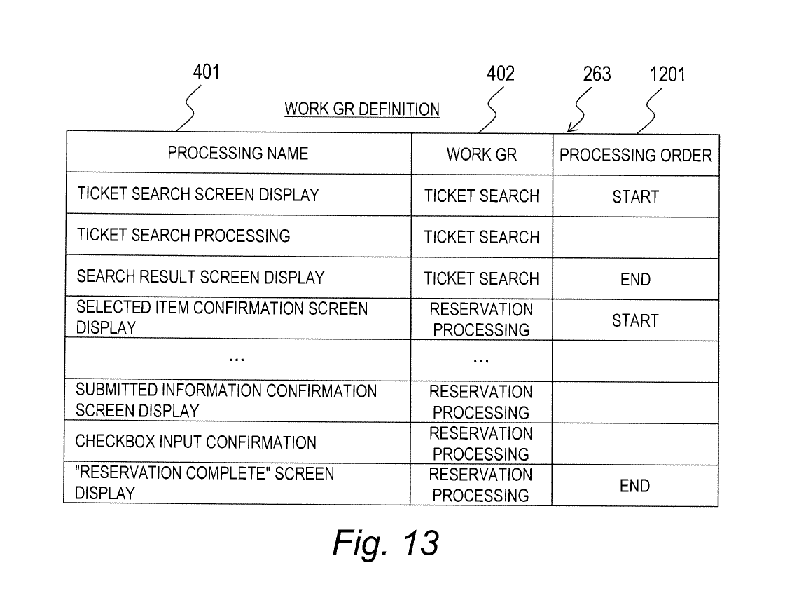

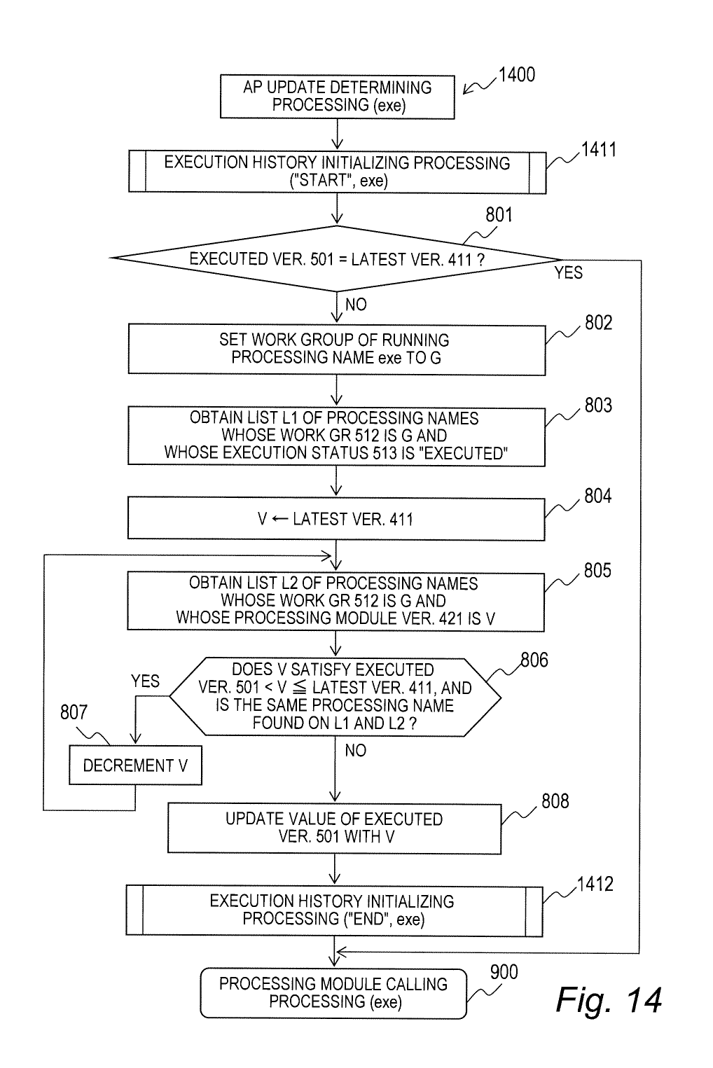

The application analyzing unit 1100 analyzes a source code of the application 100 to perform an application analysis for deter mining which processing in a work group is start processing or end processing. The result of this analysis is recorded as an processing order 1201 of a work group definition 263 (FIG. 13).

The configuration of the work group definition 263 and processing executed by an AP update determining unit 222 therefore differ from those in the first embodiment described above.

FIG. 13 is a diagram illustrating an example of the configuration of the work group definition 263 in the second embodiment.

The work group definition 263 includes the processing name 401, the work group 402, and the processing order 1201. The processing name 401 and the work group 402 are the same as those in the work group definition 163 (FIG. 5C) of the first embodiment described above. The processing order 1201 is information indicating for each processing process whether the processing process is start processing or end processing.

FIG. 14 is a flow chart illustrating a processing procedure that is executed by the AP update determining unit 222 in the second embodiment.

AP update determining processing 1400 of the second embodiment is obtained by newly adding Steps 1411 and 1412 to the AP update determining processing 800 (FIG. 9) of the first embodiment. Steps 801 to 808 in the AP update determining processing 1400 of the second embodiment are the same as Steps 801 to 808 in the AP update determining processing 800 of the first embodiment, and descriptions thereof are omitted.

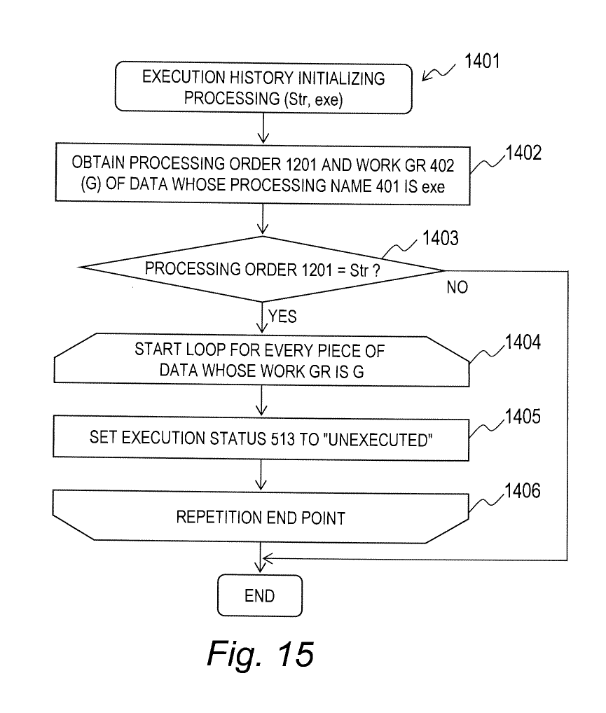

In Steps 1411 and 1412, execution history initializing processing 1401 is executed. When executing this processing, a letter string (“start” or “end”) and the running processing name exe are specified as arguments. As the letter string that is an argument, “start” is input in Step 1411 and “end” is input in Step 1412. Details of the execution history initializing processing 1401 are described later with reference to FIG. 15.

While the AP update determining processing 1400 of FIG. 14 initializes an execution history at the start of the processing (Step 1411) and the end of the processing (Step 1412), it is sufficient if an execution history is initialized at one of the time when the processing is started and the time when the processing is ended.

FIG. 15 is a flow chart illustrating a procedure of the execution history initializing processing 1401 in the second embodiment.

A letter string Str and the running processing name exe are input as arguments in the execution history initializing processing 1401.

First, the work group definition 263 is searched for data in which the value of the processing name 401 equals the running processing name exe, and the values of the processing order 1201 and work group 402 of the found data are obtained, and then the obtained value of the work group 402 is set to G (Step 1402).

Next, whether or not the processing order 1201 obtained in Step 1402 and the letter string Str match is determined (1403). When it is found as a result that the two do not match, it is not time to initialize the execution history, and this processing 1401 is ended.

When the two match, on the other hand, this is the start or end of a work group and it is time to initialize the execution history of the work group. A procedure of Step 1405 is therefore repeated for data in which the value of the work group 512 equals the work group G (Step 1404).

In Step 1405, the value of the execution status 513 of the execution history 152 is set to “unexecuted” (Step 1405).

After the procedure of Step 1405 is finished for every processing, the loop is ended (Step 1406).

As has been described, according to the second embodiment, the application analyzing unit 1100 adds the processing order 1201 to the work group definition 163. The AP update determining unit 222 uses the processing order 1201 to execute execution history initializing processing. By initializing an execution history, in the case where processing of a work group is executed again without logging in anew after the user executes processing of a modified application once, the application can be modified again.

In addition, as in the first embodiment of this invention, an application can be modified quickly even while processing of the application is being executed, without causing processing inconsistency, instead of being modified at predetermined timing.

### Third Embodiment

A third embodiment is described next.

In the third embodiment of this invention, an organization of a user who accesses the application executing device 100 is identified to determine for each organization whether or not application modification is to be allowed, and then a processing module is called up. This way, an application can be modified without causing processing inconsistency even while processing of the application is being executed and, furthermore, application modification can be conducted on an organization basis.

The third embodiment is also applicable to cases where any other types of attribute information than the user's organization (for example, post) are used.

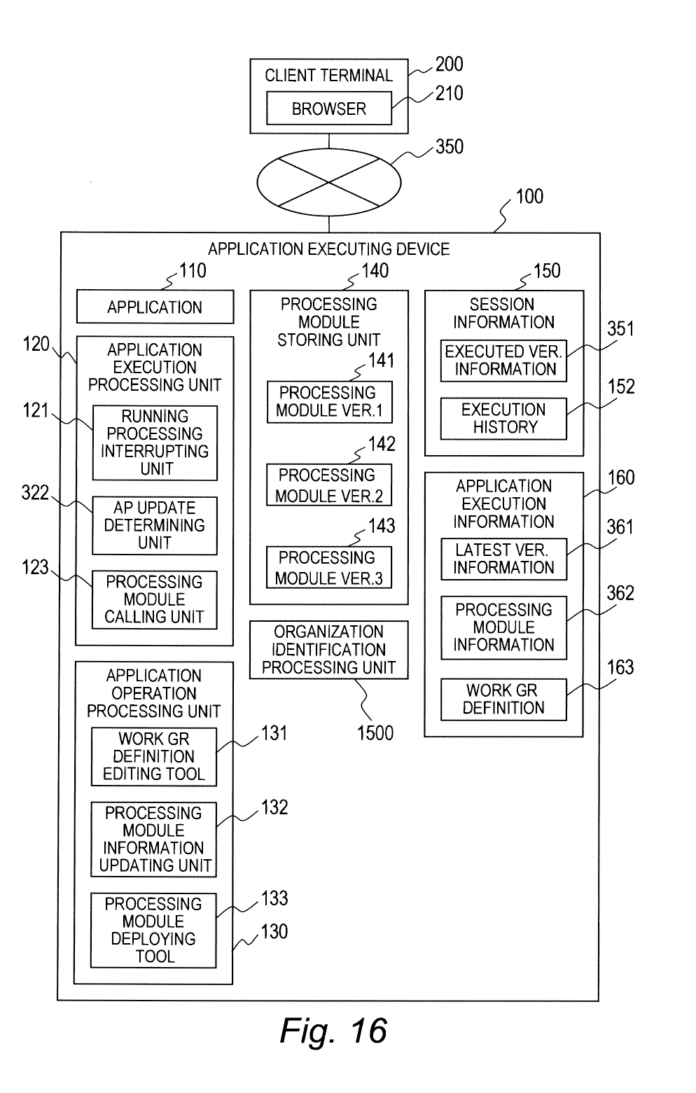

FIG. 16 is an overall configuration diagram of a computer system according to the third embodiment.

The computer system of the third embodiment includes the application executing device 100 and the client terminal 200, which are coupled to each other by the network 350. Components that are the same as in the first embodiment described above are denoted by the same symbols and descriptions thereof are omitted.

The application executing device 100 of the third embodiment includes an organization identification processing unit 1500 in addition to the same components as those in the first embodiment described above. The organization identification processing unit 1500 functions by executing an installed program with the processor.

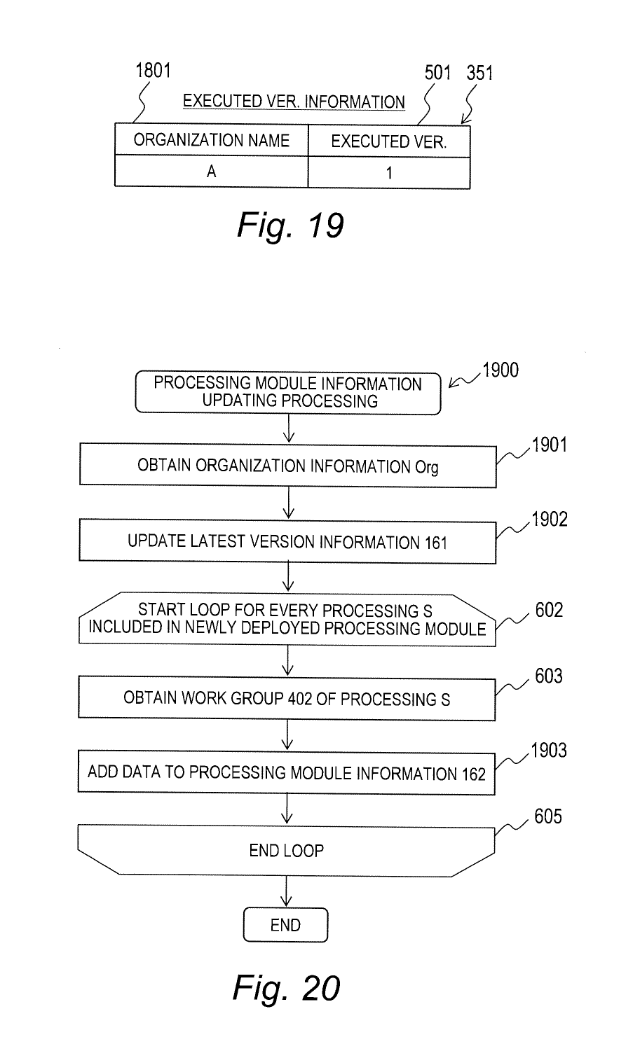

The organization identification processing unit 1500 identifies organization information of a user who accesses from the browser 210 of the client terminal 200. The application executing device 100 manages data that associates an identifier and organization information of the user. For each piece of identified organization information, executed version information 351 is recorded (see FIG. 19).

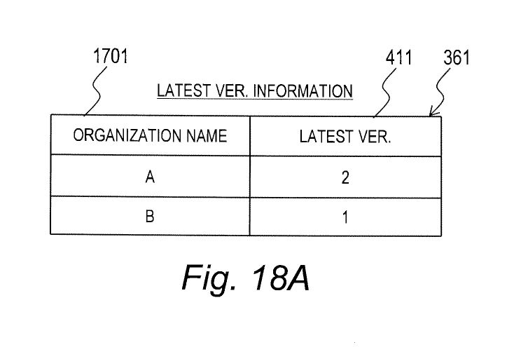

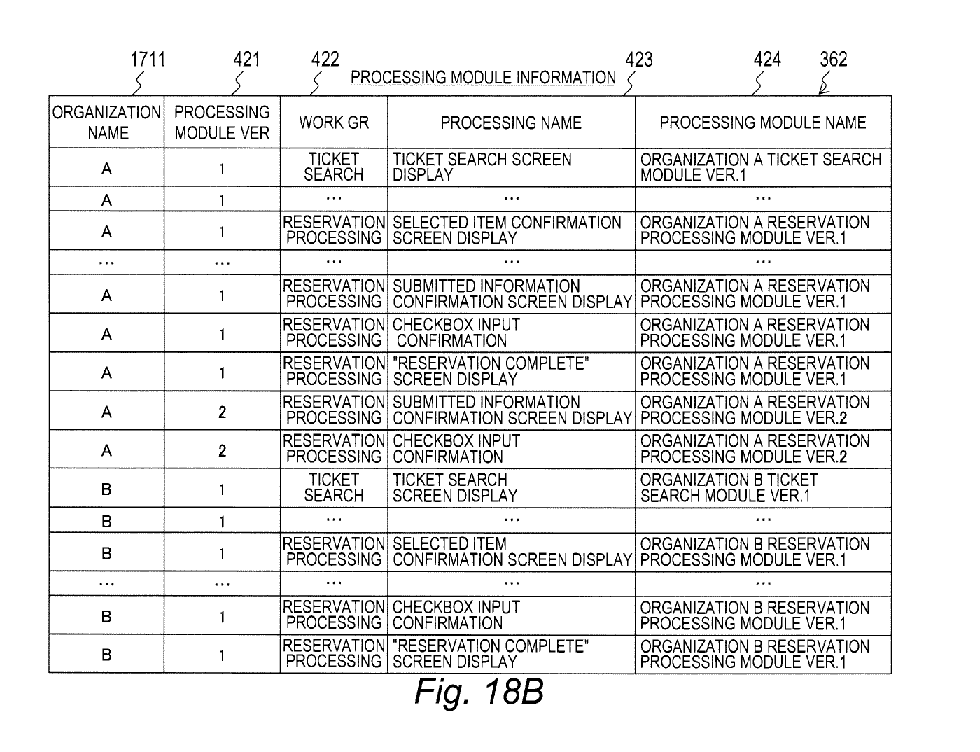

The latest version 411 is stored in latest version information 361 for each organization name 1701 (see FIG. 18A), and processing information 421 to processing information 424 are stored in processing module information 362 for each organization name 1711 (see FIG. 18B).

Processing executed by the AP update determining unit 322 therefore differs from the processing in the first embodiment described above.

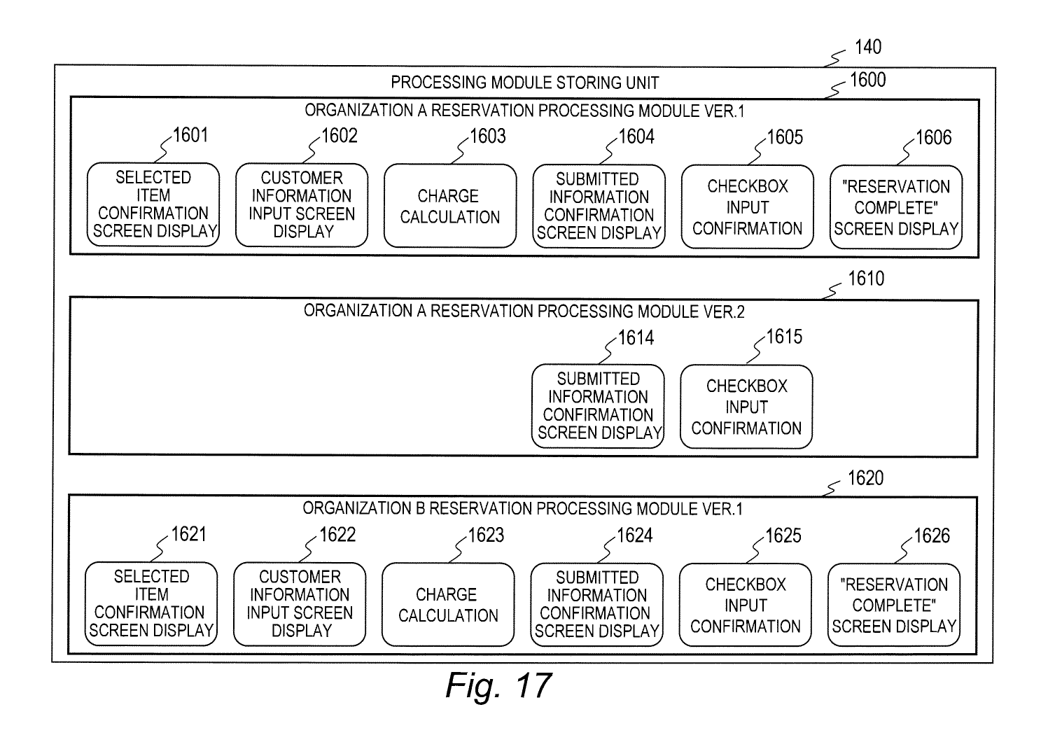

FIG. 17 is a configuration diagram of processing modules that are stored in the processing module storing unit 140 in the third embodiment.

The processing modules are separated by organization and by work group, and are also provided on a processing module version basis. When the version of a processing module associated with one work group of one organization is upgraded, only modified (upgraded) processing in the work group is included in a processing module of the next version.

For example, an organization A reservation processing module version 1 (1600) of FIG. 17 includes selected item confirmation screen display processing 1601, customer information input screen display processing 1602, charge calculation processing 1603, submitted information confirmation screen display processing 1604, checkbox input confirmation processing 1605, and “reservation complete” screen display processing 1606, which correspond to processing processes included in a work group. An organization A reservation processing module version 2 (1610) which is an upgraded version includes submitted information confirmation screen display processing 1614 and checkbox input confirmation processing 1612 in which processing specifics have been modified. An organization B reservation processing module version 1 (1620) includes selected item confirmation screen display processing 1621, customer information input screen display processing 1622, charge calculation processing 1623, submitted information confirmation screen display processing 1624, checkbox input confirmation processing 1625, and “reservation complete” screen display processing 1626, which correspond to processing processes included in a work group. The organization B reservation processing module version 1 (1620) has the same configuration as that of the organization A reservation processing module version 1 (1600), and may be the same as or differ from the organization A reservation processing module version 1 (1600) in processing specifics.

The organization A reservation processing module version 1 (1600) and the organization B reservation processing module version 1 (1620) are included in the processing module version 1 (141), and the organization A reservation processing module version 2 (1610) is included in the processing module version 2 (142).

FIG. 18A is a diagram illustrating an example of the configuration of the latest version information 361 in the third embodiment.

The latest version information 361 includes the organization name 1701 and the latest version 411. The organization name 1701 indicates an organization to which a user belongs. The latest version 411 indicates for each organization the latest version among processing modules stored in the processing module storing unit 140.

FIG. 18B is a diagram illustrating an example of the configuration of the processing module information 362 in the third embodiment.

The processing module information 362 includes an organization name 1711, the processing module version 421, the work group 422, the processing name 423, and the processing module name 424. The organization name 1711 indicates an organization to which a user belongs. The processing module version 421, the work group 422, the processing name 423, and the processing module name 424 each show organization-based information. In other words, the processing module information 362 of the third embodiment indicates, for each organization, work group, and processing module version, which processing module is to be called up.

FIG. 19 is a diagram illustrating an example of the executed version information 351 in the third embodiment.

The executed version information 351 includes an organization name 1801 and the executed version 501. The organization name 1801 indicates an organization to which an accessing user belongs. The executed version 501 indicates for each organization the processing module version of each processing that is being executed at present.

FIG. 20 is a flow chart illustrating the processing that is executed by the processing module information updating unit 132 in the third embodiment.

In processing module information updating processing 1900 of the third embodiment, Step 1901 is added to the processing module information updating processing 600 (FIG. 7) of the first embodiment, Step 1902 is executed in place of Step 601, and Step 1903 is executed in place of Step 604. Steps 602, 603, and 605 in the processing module information updating processing 1900 of the third embodiment are the same as Steps 602, 603, and 605 in the processing module information updating processing 600 of the first embodiment, and descriptions thereof are omitted.

First, an operator uses the processing module deploying tool 133 to store a new processing module in the processing module storing unit 140. At this point, organization information Org that is associated with the newly deployed processing module is input in the processing module deploying tool 133. Thereafter, the processing module deploying tool 133 calls up the processing module information updating module 132, which executes the processing module information updating processing 1900.

First, the input organization information Org is obtained from the processing module deploying tool 133 (Step 1901).

The latest version information 361 is searched for data in which the value of the organization name 1701 equals the organization information Org, and the value of the latest version 411 of the found data is updated with a value obtained by incrementing the current value by 1, and then the latest version 411 is set to the variable V (Step 1902).

Thereafter, Step 602 starts a loop for every processing (S) included in the newly deployed processing module (Step 602) to execute the procedure of Step 603.

Data containing the following items is then added to the processing module information 362 (Step 1903):

Organization name 1711=Org

Processing module version 421=V

Work group 422=G

Processing name 423=S

Processing module name 424=“organization”+Org+S+“module”+V

After the procedure of Steps 603 and 1903 is finished for every processing S, the loop is ended (Step 605).

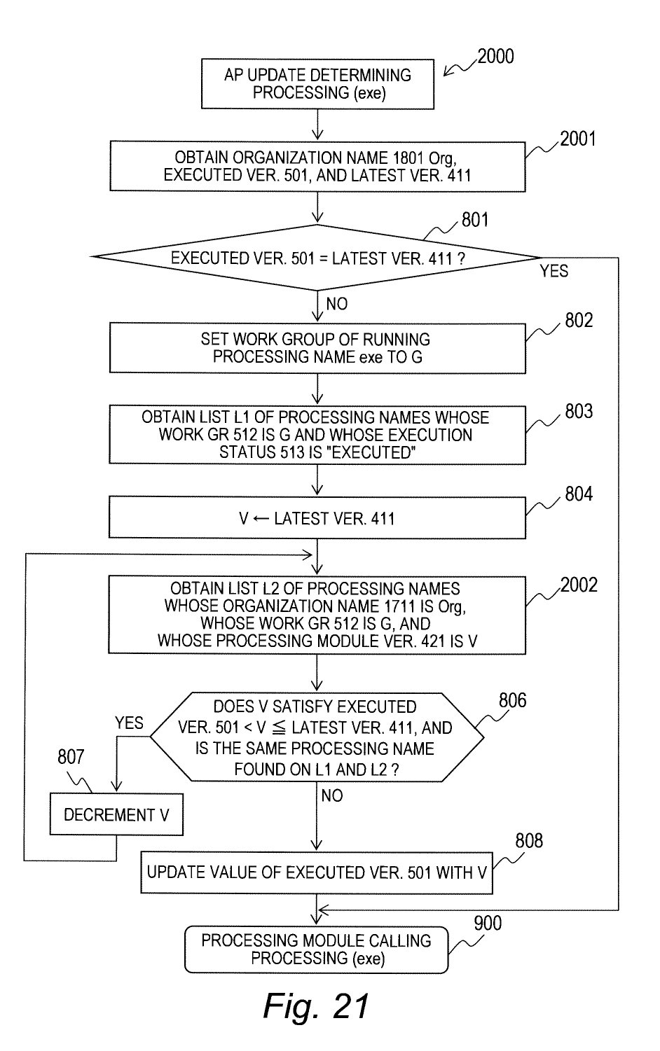

FIG. 21 is a flow chart illustrating a processing procedure that is executed by the AP update determining unit 322 in the third embodiment.

In AP update determining processing 2000 of the third embodiment, Step 2001 is added to the AP update determining processing 800 (FIG. 9) of the first embodiment, and Step 2002 is executed in place of Step 805. Steps 801 to 804 and Steps 806 to 808 in the AP update determining processing 2000 of the first embodiment are the same as Steps 801 to 804 and Steps 806 to 808 of the AP update determining processing 800 of the first embodiment, and descriptions thereof are omitted.

The running processing name exe is input as an argument in the AP update determining processing 2000.

First, the AP update determining unit 322 obtains from the executed version information 351 the value of the organization name 1801 and the value of the executed version 501, and sets the obtained value of the organization name 1801 to Org. The AP update determining unit 322 also obtains the value of the latest version 411 of data in which the value of the organization name 1701 equals the organization name Org (Step 2001).

The procedure of Steps 801 to 804 is then executed.

Thereafter, the processing name 423 that has the organization name Org as the value of the organization name 1711, the work group G as the value of the work group 422, and the version V as the value of the processing module version 421 is extracted from the processing module information 162 to obtain the list L2 (Step 2002).

The procedure of Steps 806 to 807 is then executed. When the condition of Step 806 is satisfied, the AP update determining unit 322 updates the value of the executed version 501 of the executed version information 351 with V (Step 808) and calls up the processing module calling unit 123.

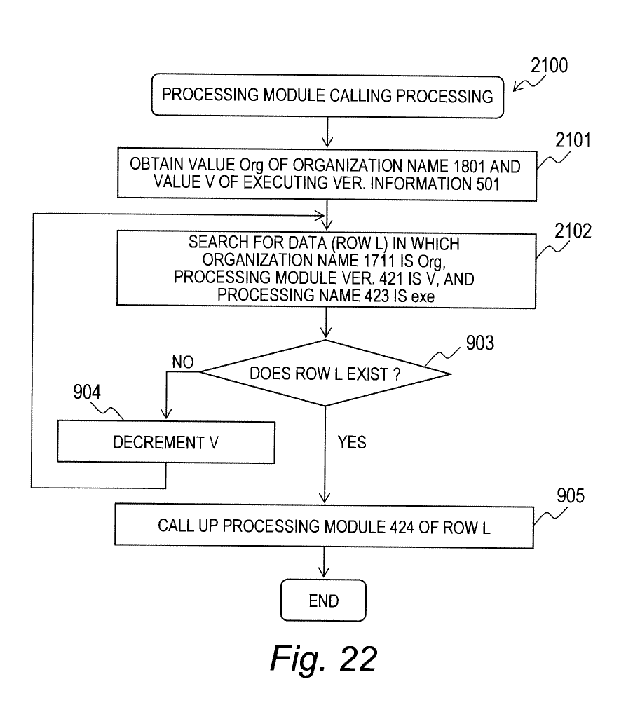

FIG. 22 is a flow chart illustrating a processing procedure that is executed by the processing module calling unit 123 in the third embodiment.

In processing module calling processing 2100 of the third embodiment, Steps 2101 and 2102 are executed in place of Steps 901 and 902 of the processing module calling processing 900 (FIG. 10) of the first embodiment. Steps 903 to 905 in the processing module calling processing 2100 of the third embodiment are the same as Steps 903 to 905 in the processing module calling processing 900 of the first embodiment, and descriptions thereof are omitted.

First, the processing module calling unit 123 obtains the value of the organization name 1801 and the value of the executed version 501 from the executed version information 351, sets the obtained value of the organization name to the variable Org, and sets the obtained value of the executed version to the variable V (Step 2101).

The processing module calling unit 123 next searches the processing module information 362 for data (the row L) in which the value of the organization name 1711 equals the organization name Org, the value of the processing module version 421 equals the version V, and the value of the processing name 423 equals the running processing name exe (Step 2102).

Whether or not the row L exists is then determined (Step 903). When the row L is not found, the processing module calling unit 123 decrements the version V by 1 (Step 904) and returns to Step 902. When the row L is found, the processing module calling unit 123 calls up a module that has the processing module name 424 of the row L (Step 905).

As has been described, according to the third embodiment, the organization identification processing unit 1500 adds an organization name to the executed version information 151. The processing module calling unit 123 executes processing of an application. By identifying organization information, a single application executing device can be shared among users of a plurality of organizations, and application modification timing and specifics of processing executed by an application can be varied from one organization to another.

In addition, as in the first embodiment, an application can be modified quickly even while processing of the application is being executed, without causing processing inconsistency, instead of being modified at predetermined timing.

This invention is applied to a computer system which executes an application program to loosen limitations on application modification timing and modify an application quickly.

1. A program execution method, which is to be performed in a computer for executing an application program including at least one processing module,
the at least one processing module including at least one process, and being managed with an identification,
the computer including an AP update determining unit for determining modification timing of a processing module to be executed, and a processing module calling unit for calling up a processing module,
the program execution method including the steps of:
determining, by the AP update determining unit, whether the processing module to be executed needs modification by comparing the identification of a running processing module and the identification of a deployed processing module;
determining, by the AP update determining unit, the identification of the processing module to be executed based on history information, which indicates whether the each process included in the at least one processing module has been executed, and on information indicating a different process between the at least one process included in the running processing module and the at least one process included in the deployed processing module; and
calling up, by the processing module calling unit, the processing module by specifying the identification of the processing module determined by the AP update determining unit.

2. The program execution method according to claim 1, wherein the step of determining of the identification includes the steps of:
obtaining a first list which indicates whether the at least one process included in the at least one processing module has been executed;
obtaining a second list which indicates a modified process included in a processing module that has the each identification;
comparing the first list and the second list to determine whether process is included in both of the first list as executed process and the second list as process needing modification; and
determining, as the identification of the processing module to be executed, a latest identification of the processing module for process that is not listed in one of the first list as the executed processing and the second list as the processing needing modification.

3. The program execution method according to claim 2,
wherein the at least one process is grouped into at least one work group, and
wherein the step of determining of the identification includes the steps of:
comparing the first list and the second list to determining whether process included in the at least one work group is included in both of the first list as the executed processing and the second list as the processing needing modification; and
determining, as the identification of the processing module to be executed, a latest identification for processing in the at least one work group that is not listed in one of the first list as the executed processing and the second list as the processing needing modification.

4. The program execution method according to claim 3,
wherein the computer includes an application analyzing unit for analyzing the application program and identifying at least one of start process and end process of the each of the at least one processing module, and
wherein the program execution method includes the step of initializing the history information in a case where process to be executed is one of the start process and the end processing.

5. The program execution method according to claim 1,
wherein the computer includes an organization identification processing unit for identifying organization information of a user who accesses the computer, and
wherein the step of the determining of the identification includes the step of determining the identification of the processing module by referring to the identified organization information for each of the organization.

6. A computer system, comprising a computer for executing an application program including at least one processing module, the at least one processing module being managed with an identification,
wherein the at least one processing module includes at least one process,
wherein the computer includes an AP update determining unit for determining modification timing of a processing module to be executed, and a processing module calling unit for calling up a processing module,
wherein the AP update determining unit is configured to:
determine whether the processing module to be executed needs modification by comparing the identification of a running processing module and the identification of a deployed processing module; and
determine the identification of the processing module to be executed based on history information, which indicates whether the each process included in the at least one processing module has been executed, and on information indicating a different process between the at least one process included in the running processing module and the at least one process included in the deployed processing module, and
wherein the processing module calling unit calls up the processing module by specifying the identification of the processing module determined by the AP update determining unit.

7. The computer system according to claim 6, wherein the AP update determining unit is configured to:
obtain a first list which indicates whether the at least one process included in the at least one processing module has been executed;
obtain a second list which indicates a modified process included in a processing module that has the each identification;
compare the first list and the second list to determine whether process is listed included in both of the first list as executed process and the second list as process needing modification; and
determine, as the identification of the processing module to be executed, a latest identification of the processing module for process that is not listed in one of the first list as the executed processing and the second list as the processing needing modification.

8. The computer system according to claim 7,
wherein the at least one process is grouped into at least one work group, and
wherein the AP update determining unit is configured to:
compare the first list and the second list to determine whether process included in the at least one work group is included in both of the first list as the executed processing and the second list as the processing needing modification; and
determine, as the identification of the processing module to be executed, a latest identification for processing in the each of the at least one work group that is not listed in one of the first list as the executed processing and the second list as the processing needing modification.

9. The computer system according to claim 8,
wherein the computer includes an application analyzing unit for analyzing the application program and identifying at least one of start process and end processing of the each of the at least one process module, and
wherein the AP update determining unit is configured to initialize the history information in a case where process to be executed is one of the start process and the end process.

10. The computer system according to claim 6,
wherein the computer includes an organization identification processing unit for identifying organization information of a user who accesses the computer, and
wherein the AP update determining unit is configured to determine the identification of the processing module to be executed by referring to the identified organization information for each of the organization.

11. A machine-readable medium containing at least one sequence of instructions for controlling a computer to execute an application program including at least one processing module,
the at least one processing module including at least one process, and being managed with an identification,
the computer including an AP update determining unit for determining modification timing of a processing module to be executed, and a processing module calling unit for identifying and calling up a processing module,
the at least one sequence of instructions causing the computer to:
determine, by the AP update determining unit, whether the processing module to be executed needs modification by comparing the identification of a running processing module and the identification of a deployed processing module;
determine, by the AP update determining unit, the identification of the processing module to be executed based on history information, which indicates whether the each process included in the at least one processing module has been executed, and on information indicating a different process between the at least one process included in the running processing module and the at least one process included in the deployed processing module; and
call up, by the processing module calling unit, the processing module by specifying the identification of the processing module determined by the AP update determining unit.

12. The machine-readable medium according to claim 11, the at least one sequence of instructions further causing the computer to:
obtain a first list which indicates whether the at least one process included in the at least one processing module has been executed;
obtain a second list which indicates a modified process included in a processing module that has the each identification;
comparing the first list and the second list to determine whether process is included in both of the first list as executed processing and the second list as processing needing modification; and
determine, as the identification of the processing module to be executed, a latest identification of the processing module for processing that is not listed in one of the first list as the executed processing and the second list as the processing needing modification.

13. The machine-readable medium according to claim 12,
wherein the at least one process is grouped into at least one work group, and
wherein, in the determining of the identification, the at least one sequence of instructions causes the computer to:
compare the first list and the second list to determine whether process included in the at least one work group is included in both of the first list, as the executed processing and the second list as the processing needing modification; and
determine, as the identification of the processing module to be executed, a latest identification for processing in the each of the at least one work group that is not listed in one of the first list as the executed processing and the second list as the processing needing modification.

14. The machine-readable medium according to claim 13,
wherein the computer includes an application analyzing unit for analyzing the application program and identifying at least one of start process and end process of the each of the at least one processing module, and
wherein the at least one sequence of instructions causes the computer to initialize the history information in a case where process to be executed is one of the start process and the end process.

15. The machine-readable medium according to claim 11,
wherein the computer includes an organization identification processing unit for identifying organization information of a user who accesses the computer, and
wherein, in the determining of the identification, the at least one sequence of instructions causes the computer to execute determining the identification of the processing module to be executed by referring to the identified organization information for each organization.
